(19) United States
(12) Patent Application Publication
(10) Pub. No.: US 2006/0001661 A1
(43) Pub. Date: Jan. 5, 2006

(54) Display device and television device

(75) Inventor: Makiko Mori, Atsugi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/165,165

(22) Filed: Jun. 24, 2005

(30) Foreign Application Priority Data
Jun. 30, 2004 (JP) 2004-193946

(51) Int. Cl. G09G 5/00

(52) U.S. Cl. 345/211

(57) ABSTRACT

It enables to promptly display an input video in a display mode, to apply a voltage according to the content of an execution process in a process mode, and to appropriately execute start control in each mode. More specifically, a display device which has a display panel, row and column wiring drivers for driving the display panel and a driving power source for supplying power to the drivers has the display (image displaying from an image source) mode and the process mode. The driving power source is controlled based on an externally input command to apply the voltage according to the content of the execution process in the process mode, and the driving power source is controlled based on a predetermined sequence in the display mode. Thus, an input video can be promptly displayed, whereby the start control can be appropriately executed.

### BACKGROUND OF THE INVENTION

1. Field of the Invention

The present invention relates to a display device and a television device. In particular, the present invention relates to a display device which has a process mode for adjustment and a display mode for image display (that is, displaying an image from an image source).

2. Related Background Art

Japanese Patent Application Laid-Open No. 2003-036050 (hereinafter called the document 1) discloses an electron emission device which applies a characteristic shift voltage so that the electron emission characteristic of each of plural surface-conduction electron-emitters (hereinafter called SCE's) comes to have a reference value. Here, the driving circuit shown in FIG. 1 of the document 1 has a function for causing the display panel to display an image based on an image signal, a function for measuring and detecting an electron emission current in each SCE, and a function for applying a pulse-shape signal for characteristic shift according to the detected electron emission current.

Further, Japanese Patent Application Laid-Open No. 08-088574 (hereinafter called the document 2) discloses an electronic device which enables an adjustment mode in a case where a predetermined signal has been input when the power source is turned on, and enables a user mode in a case where the predetermined signal is not input when the power source is turned on. More specifically, in the adjustment mode of the document 2, each circuit of the electronic device is controlled in response to average setting data, and the setting data adjusted in response to a control signal input from an external device is controlled to be stored in the memory. Meanwhile, in the user mode of the document 2, each circuit of the electronic device is controlled in response to the adjusted setting data. Besides, Japanese Patent Application Laid-Open No. 2000-250463 (hereinafter called the document 3) discloses an image display device in which luminance can be smoothly changed by an automatic luminance limitation circuit.

However, the devices described in the documents 1 to 3 include the following problem to be solved.

For example, as described above, the electron emission device of the document 1 has the three driving functions concerning image display driving, characteristic measurement driving, and characteristic shift driving. Here, after the power source of the electron emission device is turned on, it is required in the image display driving to immediately apply an anode voltage and a driving voltage to the display panel so as to display the image based on an input video signal.

Meanwhile, in the characteristic measurement driving and the characteristic shift driving, the display panel is driven according to respectively different (independent) driving conditions. However, even in such a situation, in the electron emission device of the document 1, switching of the driving is not necessarily executed smoothly. Moreover, in the manufacturing process, if an unnecessary voltage is applied to the SCE, there is a possibility of influencing the characteristic of the SCE. However, an effective countermeasure for the above possibility is insufficient conventionally. Moreover, according to the circumstances, a process of applying only a driving voltage but not applying an acceleration voltage is within the bounds of possibility, and vice versa. For this reason, the conventional display device which automatically applies the voltage to the display panel after the power source was turned on is not sufficiently adaptive to the manufacturing process.

### SUMMARY OF THE INVENTION

In consideration of such problems as above, an object of the present invention is to provide a display device and a television device which deal with both a process mode for adjustment of the display device and the television device including characteristic measurement driving and characteristic shift driving and a display mode for image display based on a video signal from a video source, in which it is possible to achieve suitable control with respect to either mode by judging the current mode and controlling voltage apply suitable for the relevant mode.

To achieve the above object, the first invention is characterized by comprising:

a display panel adapted to display an image;

a driving unit adapted to drive the display panel; and

a driving power source unit adapted to supply power to the driving unit, and

characterized in that it is possible to set at least two modes, that is, a process mode in which the driving power source unit is controlled based on an externally input command and a display mode in which the driving power source unit is controlled based on a predetermined sequence.

Moreover, the second invention is characterized by a display device comprising.:

a display panel adapted to display an image;

a driving unit adapted to drive the display panel; and

a driving power source unit adapted to supply power to the driving unit,

wherein, after a power source is turned on, it is possible to set at least two modes, that is, a process mode of brining about a state not applying a driving voltage to the display panel and a display mode of bringing about a state of applying the driving voltage to the display panel according to the image to be displayed.

According to the present invention, when the device starts the operation in the process mode, the device is in a state of not outputting any voltage. Thus, an unnecessary voltage is not applied to the display panel and the corresponding elements, whereby it is possible to prevent that the elements are damaged by the unnecessary voltage.

Furthermore, since an acceleration voltage can be included in the target to be controlled in a start sequence, it is possible to achieve more suitable control.

Moreover, when a display pattern is processed in the process mode, the image by which the current flowing in the display panel is small in an initial state is displayed. Thus, there is a low possibility that an image by which the load to the display panel and the driving unit is large is displayed by operational error.

Moreover, since an amount of operation may be small, it is possible to shorten a processing time.

Moreover, the previous setting value can be reproduced in the display mode, and a default value suitable for the relevant process can be set in the process mode. Thus, it is possible to easily control the display panel at the time when the mode is switched.

Moreover, it is possible to promptly display the input video in the display mode, and it is possible to apply the voltage according to the content of the executed relevant process in the process mode. Therefore, it is possible to easily control the start operation of the device in each of the display (image display from image source) mode and the process mode.

### BRIEF DESCRIPTION OF THE DRAWINGS

FIG. 1 is a block diagram showing the module constitution of a display device according to the present invention;

FIG. 2 is a block diagram showing the inside of the signal processing unit in the display device according to the first embodiment of the present invention;

FIG. 3 is a flow chart showing the operation of the module control unit according to the first embodiment of the present invention;

FIG. 4 is a block diagram for explaining the power supply in the display device according to the first embodiment of the present invention;

FIG. 5 is a flow chart showing the operation of the module control unit according to the second embodiment of the present invention; and

FIG. 6 is a block diagram showing a television device according to the present invention.

### DETAILED DESCRIPTION OF THE PREFERRED EMBODIMENTS

Hereinafter, the embodiments of the present invention will be explained with reference to the attached drawings. Here, it should be noted that the portions to which the same numeral or symbol is added are all the equivalent throughout the drawings.

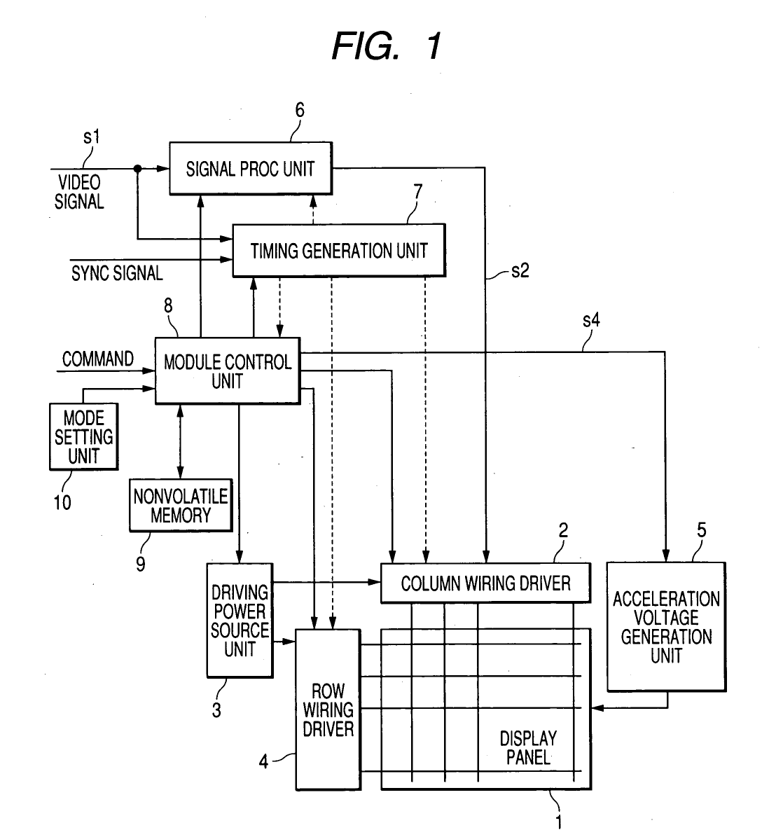

FIG. 1 is a block diagram showing a display device. Here, the display device to which the present invention is applicable includes an SED (surface-conduction electron-emitter display), an FED (field emission display), a LCD (liquid crystal display), a PDP (plasma display panel), an EL (electro luminescent) display, and the like. In particular, the SED is the preferable display device to which the present invention is applied because the manufacturing process of the SED includes measurement of characteristics, adjustment of driving, pre-driving, aging, measurement of unevenness of in-plane luminance, detection of defects, various evaluations, and the like.

Here, the display device consists of a display panel 1, a column wiring driver 2, a driving power source unit 3, and a row wiring driver 4. Moreover, in the display panel 1, plural display elements are arranged like a matrix and connected to row and column wirings respectively.

The column wiring driver 2 transforms a display signal s2 into a driving signal suitable for the display panel 1, modulates the driving voltage from the driving power source unit in response to the driving signal, and then applies the modulated driving voltage to each wiring of the display panel 1.

The driving power source unit 3 generates the voltage for driving the display elements arranged on the display panel 1, in response to an instruction from a module control unit 8. Then, the generated voltage is applied to the column wiring driver 2 and the row-wiring driver 4.

The row wiring driver 4 selectively applies the driving voltage from the driving power source unit 3to the row wirings on the display panel 1.

In a case where the display element is the electron emitter such as the SCE or the like, an acceleration voltage generation unit 5 is disposed so as to generate an acceleration voltage for accelerating the electrons emitted from the electron emitter to collide them against a fluorescent substance.

A signal processing unit 6 executes later-described various signal processes to an input video signal.

A timing generation unit 7 generates and supplies respective timing signals to the column wiring driver 2, the row wiring driver 4, the signal processing unit 6 and the module control unit 8, in response to input sync signals or sync signals separated from input video signals. The timing generation unit 7 has a function for self-generating the timing signals. For this reason, the timing generation unit 7 generates the various timing signals suitable for the display panel 1 irrespective of the input signal, in response to the instruction from the module control unit 8.

The module control unit 8 which typically consists of a microcomputer and its peripheral circuits monitors and controls respective modules. Moreover, the module control unit 8 has the function for understanding a command input from the external and executing a process in response to the input command.

A nonvolatile memory 9 is the storage unit which stores various items such as various parameters of the signal processing unit, driving parameters, and the like.

A mode setting unit 10 includes a switch so as to be able to set the mode to be used.

In the display mode, an input video signal s1 is transferred to the signal processing unit 6, subjected to various signal processes, and transformed into a display signal s2. Then, the display signal s2 is input to the column wiring driver 2. The column wiring driver 2 and the row wiring driver 4 apply modulation signals and scanning signals respectively to each row wiring and-each column wiring on the display panel 1. Thus, the display panel 1 is driven to display an image (video).

When the power source of the display device is turned on, the module control unit 8 reads the setting state of the mode setting unit 10 and executes a start-up sequence of the module according to the used mode. At that time, if the display mode is being set, the start-up process is executed so as to display the video according to the input video signal on the display panel 1. Meanwhile, if the process mode is being set, the state that any voltage is not applied to the display panel 1 is maintained.

Hereinafter, the embodiments of the present invention will be explained concretely.

### First Embodiment

In the first embodiment of the present invention, an SED panel is used as the display panel 1. Here, on the SED panel, a multi electron source in which a number of SCE's are arranged on the substrate is disposed opposite to an image forming member which forms images by irradiation of electrons, within a thin vacuum container. More specifically, the 3840 SCE's are arranged in the row direction, the 768 SCE's are arranged in the column direction, and these elements are simply arranged like a matrix by means of the 3840 row wirings and the 768 column wirings. Then, the electron which is emitted from the SCE selected by appropriately driving the row and column wirings is accelerated by high voltage to collide it against a fluorescent substance, thereby emitting light. Incidentally, for example, the above document 3 discloses in detail the constitution of the SED panel and the manufacturing method thereof.

The column wiring driver 2 receives the display signal s2 output from the signal processing unit 6, sequentially accumulates the received signals as much as one row, and then transforms the display signal s2 into the driving signal on the basis of the driving parameter set by the module control unit 8. Subsequently, the column wiring driving voltage from the driving power source unit 3 is applied to each column wiring on the display panel 1 as the modulation signal with respect to each horizontal one period (row selection period) generated by the timing generation unit 7. Here, it should be noted that the display of gradation is achieved by modulating the pulse width and/or the amplitude of the modulation signal in accordance with the display signal, and the column wiring driving voltage is set within the range of 6V to 10V.

Moreover, by the row wiring driver 4, the row wiring driving voltage from the driving power source unit 3 is sequentially selected and applied to the row wiring on the display panel 1 as the scanning signal with respect to each horizontal one period (row selection period), on the basis of the vertical and horizontal sync signals supplied from the timing generation unit 7. Here, it should be noted that the row wiring driving voltage is set within the range of −8V to −15V. Thus, the electrons of the amount corresponding to the modulation signal are emitted from the SCE connected to the selected row wiring, the emitted electrons are accelerated by the acceleration voltage, and the accelerated electrons collide against the fluorescent substance, thereby emitting light. Here, it should be noted that the acceleration voltage is set within the range of 8 kV to 10 kV.

Incidentally, a ground voltage or a predetermined bias voltage is applied to the unselected row wirings.

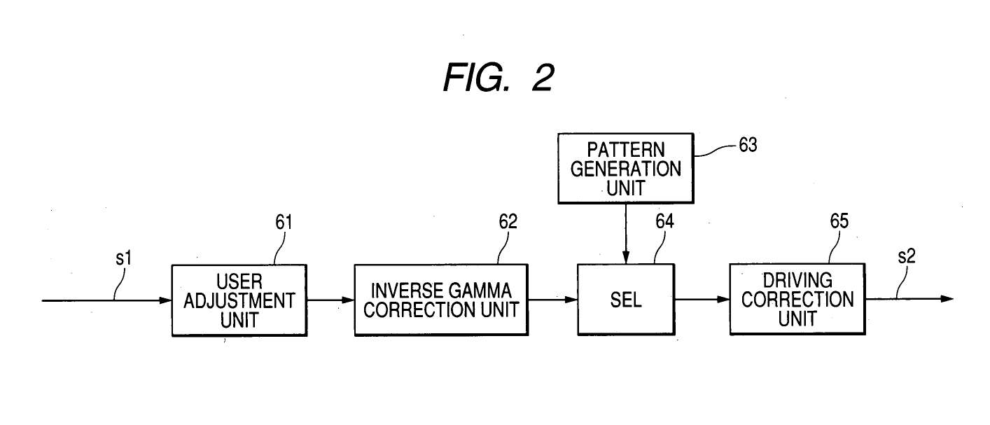

FIG. 2 is a block diagram showing the inside of the signal processing unit 6. In FIG. 2, a user adjustment unit 61 adjusts image quality such as contrast, brightness and the like of the image (video) represented by the input video signal s1. An inverse gamma correction unit 62 executes, with respect to the output signal of the user adjustment unit 61, inverse transformation of the gamma transformation executed to the video signal s1, so that the acquired signal conforms to a CRT display. A pattern generation unit 63 self-generates an arbitrary pattern to be displayed on the display panel 1. A selector (SEL) 64 can select either one of the output of the inverse gamma correction unit 62 and the output of the pattern generation unit 63. A driving correction unit 65 executes various corrections (for example, correction of luminance unevenness, correction of voltage drop, correction of the saturation of the fluorescent substance, etc.) being caused by the display panel 1 and-further executes various processes (for example, ABL (Automatic Brightness Limiter), a dither process, etc.). Then, the driving correction unit 65 outputs the corrected and processed signal as the display signal s2.

The command for the module control unit 8 is transmitted/received to/from a externally connected personal computer through serial communication, and a protocol and a command format can be achieved by the known technique. Here, it should be noted that there are various kinds of commands such as a command for ON/OFF control of the driving power source unit 3, a command for ON/OFF control of the acceleration voltage generation unit 5, a command for setting the row wiring driving voltage and the column wiring driving voltage applied from the driving power source unit 3, a command for setting the acceleration voltage, a command for switching the selection by the SEL 64, a command for setting various adjustment values, a command for ON/OFF control of various corrections, a command for setting various parameters, a command for setting the self-generated pattern, and the like.

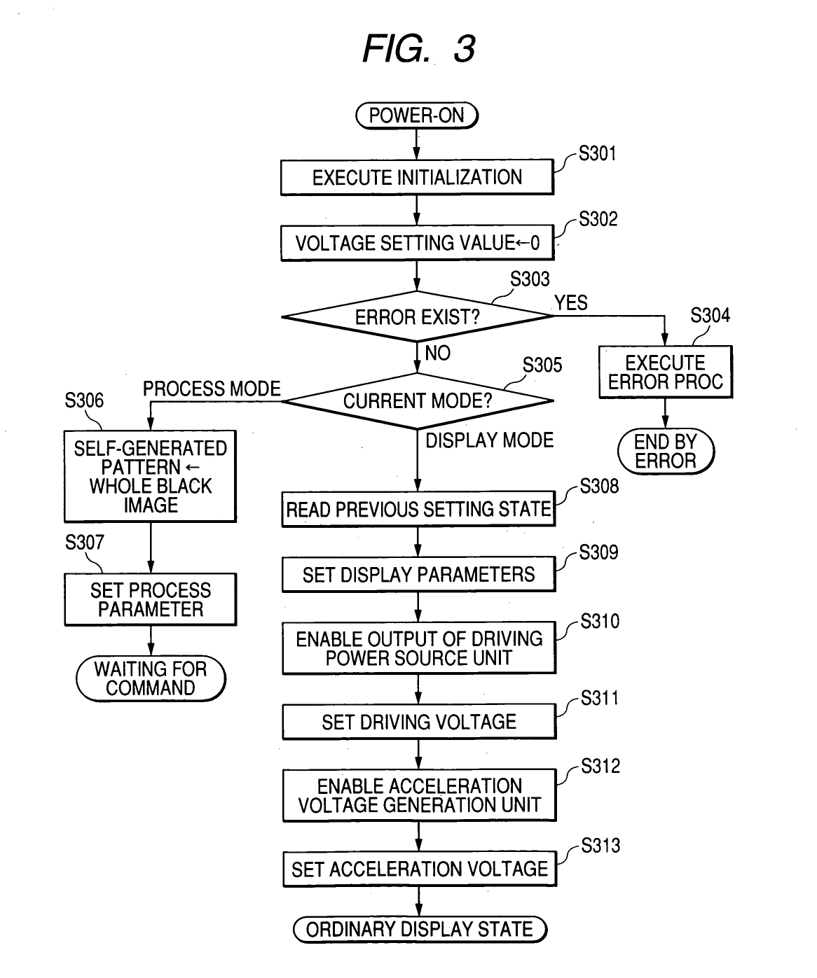

Subsequently, the operation of the microcomputer in the module control unit to be executed when the power source of the module is turned on will be explained with reference to FIG. 3. Here, the program for the relevant operation is stored in a ROM (not shown) of the module control unit.

Initially, when the power source is turned on, in a step S301, the microcomputer and its peripheral devices are initialized by the microcomputer itself. Then, in a step S302, the voltage setting values for the driving power source unit 3 and the acceleration voltage generation unit 5 are respectively set to zero. Subsequently, in a step S303, an error check is executed with respect to the whole module. When an error is found in the error check, the flow advances to a step S304 to execute an-error process.

On the contrary, when any error is not found in the error check, the flow advances to a step S305 to read the information from the mode setting unit and thus judge whether or not the process mode is set. Here, in the present embodiment, the mode setting unit 10 consists of the switch. Thus, an L-level logical signal is input to the module control unit 8 when the switch of the mode setting unit 10 is ON, while an H-level logical signal is input to the module control unit 8 when the switch is OFF.

In the manufacturing process, the switch is turned on (ON) by an operator to select and set the L level, that is, the process mode, and then the power source of the module is turned on. Moreover, before actual shipping, the switch is turned off (OFF) to set the H level, that is, the display mode.

When it is judged in the step S305 that the process mode is set, the flow advances to a step S306 to indicate the pattern generation unit 63 to designate the self-generated pattern. Here, it is assumed that the self-generated pattern is the image with low load to the display panel 1 and the column wiring driver 2. For example, the load to the display panel 1 can be measured based on the voltage, the current and the power applied and supplied to the panel, and the load to the column wiring driver 2 can be measured based on the current and the power consumed by the driver.

Moreover, in a case where a probability that an undesired discharge occurs changes dependent on the displayed image, it is also possible to consider the relevant probability as the load. In case of the SED used in the present embodiment, the image of least load to the display panel 1 and the column wiring driver 2 is a whole black image which is seen in the state that all the pixels are not lighted. Then, in a step S307, a control parameter for the process mode is set. More specifically, to display the self-generated pattern, the SEL 64 is set to switch to select the self-generated pattern and the timing generation unit 7 is set to generate self-generated timing independent of the input-signal.

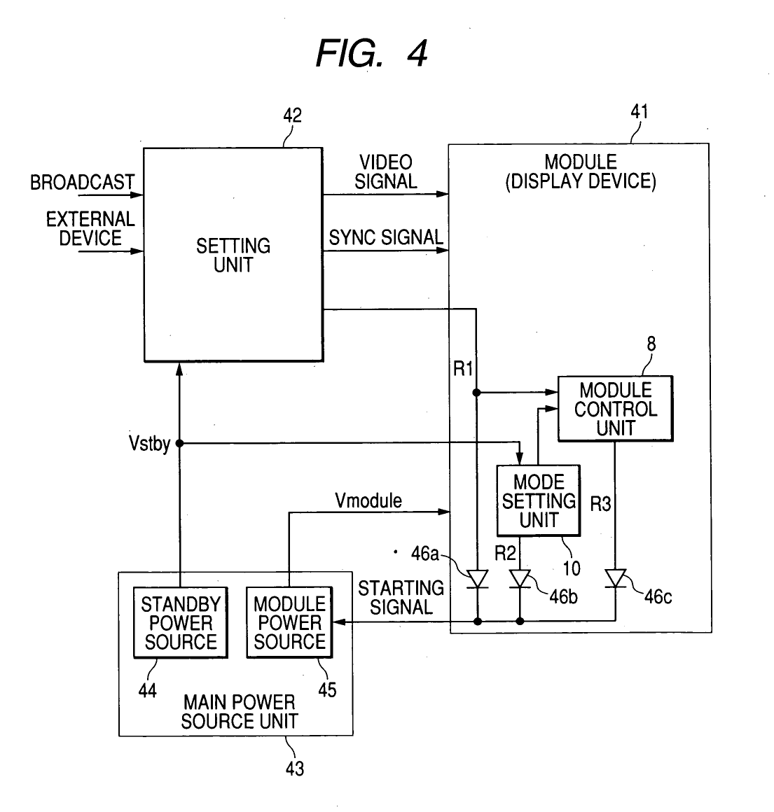

After then, a display device (or module) 41 (see FIG. 4) waits for an externally input command.

For this reason, the commands for applying to the display panel 1 the voltage suitable for the current process are sequentially issued in predetermined order from the externally connected personal computer. More specifically, the relevant commands include a command for executing various settings of the signal processing unit 6, a-command for turning ON the driving power source unit 3, a command for turning ON the acceleration voltage generation unit 5, a command for setting the row wiring driving voltage, a command for setting the column wiring driving voltage, a command for setting the acceleration voltage, and the like.

Meanwhile, when it is judged in the step S305 that the process mode is not set, then it is judged that the display mode is set, and the flow advances to a step S308 to read the display setting state in the previous display mode from the nonvolatile memory 9. Then, in a step S309, to reproduce the state read in the step S308, the driving parameters such as driving wave shapes and the like are set to the column wiring driver 2 and the row wiring driver 4. Moreover, various adjustments, ON/OFF of corrections and various parameters are set to the signal processing unit 6, and various parameters for timing signal generation based on an input sync signal are set to the timing generation unit 7.

Besides, it is possible to read luminance unevenness correction data from the nonvolatile memory 9 and transfer the read data to the driving correction unit 65. Incidentally, since it is necessary to sequentially read the luminance unevenness correction data with large capacity and based on the clock of the video signal, it is difficult to achieve such an operation by the nonvolatile memory. For this reason, when the power source is turned on, it is necessary to transfer the luminance unevenness correction data to a high-speed memory (not shown) in the signal processing unit 6. Incidentally, it is also possible to provide a large-capacity nonvolatile memory (not shown) in the sign a1 processing unit 6, and transfer the necessary data at high speed to the relevant memory when the power source is turned on.

Subsequently, in a step S310, it enables the output of the driving power source unit 3, whereby the driving power source unit 3 can apply the driving voltage set by the module control unit 8 to the column wiring driver 2 and the row wiring driver 4. However, at this stage, since the voltage setting value set in the step S302 is still zero, the driving voltage is not applied to the display panel 1 yet.

Subsequently, in a step S311, the driving voltage is set with respect to the driving power source unit 3, whereby the row wiring driving voltage and the column wiring driving voltage are output to the display panel 1. However, since any acceleration voltage is not applied, an actual display is not executed yet.

Subsequently, in a step S312, it enables the output of the acceleration voltage generation unit 5, whereby the acceleration voltage generation unit 5 can apply the acceleration voltage set by the module control unit 8 to the display panel 1. However, at this stage, since the voltage setting value set in the step S302 is still zero, the acceleration voltage is not applied to the display panel 1.

In a step S313, the acceleration voltage is set with respect to the acceleration voltage generation unit 5. In consequence, a video based on the input video signal is displayed on the display panel, and a typical video display operation state starts.

By the above control, it is possible in the display mode to promptly display the input video, and it is possible in the process mode not to apply an unnecessary voltage to the display panel and the relevant elements, whereby it is resultingly possible to appropriately execute start control in each mode

Moreover, it is possible to implement an output enable function in the column wiring driver 2 and the row wiring driver 4 so that the output enable control signal is switching-controlled from the module control unit 8. Incidentally, by adding output enable control commands for the column wiring driver 2 and the row wiring driver 4 and a designated frame number display command to the commands issued from the external personal computer, it is possible to achieve the driving, such as pre-driving, luminance unevenness measurement driving and the like, in which the number of driving frames is strictly managed.

Next, the power supply to the display device will be explained with reference to FIG. 4. In FIG. 4, the display device (or module) 41 includes all the constituent components shown in FIG. 1. For this reason, the constituent components in FIG. 4 same as those in FIG. 1 are denoted by the corresponding same numerals and symbols respectively, and the concrete explanation thereof will be omitted.

A setting unit 42 transforms television broadcast wave signals and signals input from external devices such as a DVD recorder, a video camera and the like into the video signal of a prescribed format, and outputs the acquired video signal to the module 41. Here, it should be noted that a tuner unit used to receive these signals may be built in or externally provided.

A main power source unit 43 inputs an AC and then supplies necessary power to the setting unit 42 and the module 41, and the main power source unit 43 consists of a standby power source 44 and a module power source 45. When the AC is supplied, the standby power source 44 starts to output the power but the module power source 45 does not start to output the power. Incidentally, the cathode sides of respective diodes 46a, 46b and 46c are commonly connected together.

Next, the operation of the power source will be explained.

In the display mode, the setting unit 42 is being connected to the module 41, whereby a power Vstby is supplied from the standby power source 44 to the setting unit 42 in the state that an AC is supplied. Then, when the power source is turned ON by a remote controller or the like, the setting unit 42 sets a signal R1 to an H level and also sets a starting signal to an H level through the diode 46a. When the starting signal is set to the H level, the module power source 45 starts to output a power Vmodule to the module 41, whereby the circuits including the module control unit 8 in the module 41 respectively start their operations, and a signal R3 is set to an H level.

Meanwhile, in the process mode, the setting unit 42 is not implemented, whereby only the module 41 and the main power source unit 43 are provided. Therefore, since the signal R1 is not set to the H level, a signal R2 is set to an H level by the power Vstby when the process mode is being selected and set by the mode setting unit 10. Then, the starting signal is set to the H level through the diode 46a in response to the signal R2, whereby the module power source 45 starts to output the power Vmodule to the module 41, whereby the circuits including the module control unit 8 in the module 41 respectively start their operations, and the signal R3 is set to the H level.

Incidentally, in the mode setting unit, each of the mode selection switch and the switch for setting the signal R2 to the H level may be provided independently. That is, when the operation ends, it is detected by the module control unit 8 that the signal R1 is set to an L level by the setting unit 42 or the signal R2 is set to an L level by the switching, and an end process is executed. In the end process, when the display mode is being set, the current value of the parameter to be read in the step S309 is stored in the nonvolatile memory 9. After the end process completed, the signal R3 is set to an L level, whereby the starting signal is set to an L level. As a result, the module power source 45 stops the outputting, and it is thus interrupted to supply the power Vmodule.

In the first embodiment, the three diodes as above are used. However, the same operation can be achieved even if an IC which executes a logical OR operation by the power Vstby is used.

Moreover, in the above explanation, the ON/OFF of the output is executed by the module power source 45 in response to the starting signal. However, it is also possible to control supply/interruption of the power Vmodule by setting the module power source 45 to always output the power and also supplying the starting signal by using a switch.

Subsequently, the parameter setting of the timing generation unit 7 will be explained with reference to the following table.

TABLE 1

| Condition | Input of | OK | | | NG (including no setting unit) | |
|---|---|---|---|---|---|---|
| | setting unit | | | | | |
| | Input of | OK | NG | OK | OK | NG |
| | module | | | | | |

| | | | |
|---|---|---|---|
| Mode | Don't care | Process | Image display from |
| | | | image source |

| | | | | | |
|---|---|---|---|---|---|
| Judgment | Normal | Abnormal | NOSYNC | Stand | NOSYNC |
| | | | | alone | |
| Timing generation | Following | Error | Following | Self | Waiting for input |
| | up input | (not | up input | generation | self generation |
| | | driving) | | | |

Then, the timing generation method to be set to the timing generation unit 7 is selected based on the following three input conditions.

(1) a logical signal representing whether or not there is an input signal to the setting unit 42

(2) judgment as to whether or not the video signal and the sync signal to be input to the module 41 are in predetermined timing

(3) a setting mode of the mode setting unit 10

That is, judgment and setting are executed as follows, based on these three input conditions.

First, if both the input conditions (1) and (2) are OK, the video signal is normally input. Thus, the parameter of the timing generation unit 7 is set so as to follow up the input.

Second, if the input condition (1) is OK and the input condition (2) is NG, the video signal is input to the setting unit 42 but not input to the module 41. That is, the timing generation unit 7 is in an abnormal state to be judged as an error, whereby the display panel is not driven.

Third, if the input condition (1) is NG and the input condition (2) is OK, it is judged that the video signal is not supplied to the setting unit 42 but a self-generated signal is output. Therefore, the parameter of the timing generation unit 7 is set so as to follow up the input.

Fourth if the input condition (1) is NG or the setting unit 42 does not exist and also the input condition (2) is NG, when the setting state of the mode setting unit 10 is the process mode, it is judged that the timing generation unit 7 is stand alone, whereby it is set to generate self-generated timing. Meanwhile, when the setting state of the mode setting unit 10 is the display mode, it is judged that there is no input although it waits for an input signal. Therefore, the parameter of the timing generation unit 7 is set so as to generate self-generated timing until the input signal is supplied and then follow up the input signal as soon as the input signal is supplied.

### Second Embodiment

In the first embodiment, the timing for enabling the outputs from the driving power source unit 3 and the acceleration voltage generation unit 5 is set only in the so-called image display (image displaying from image source) mode in the steps S310 and S312. However, in the second embodiment, the above operation is executed at that stage of confirmation of no error.

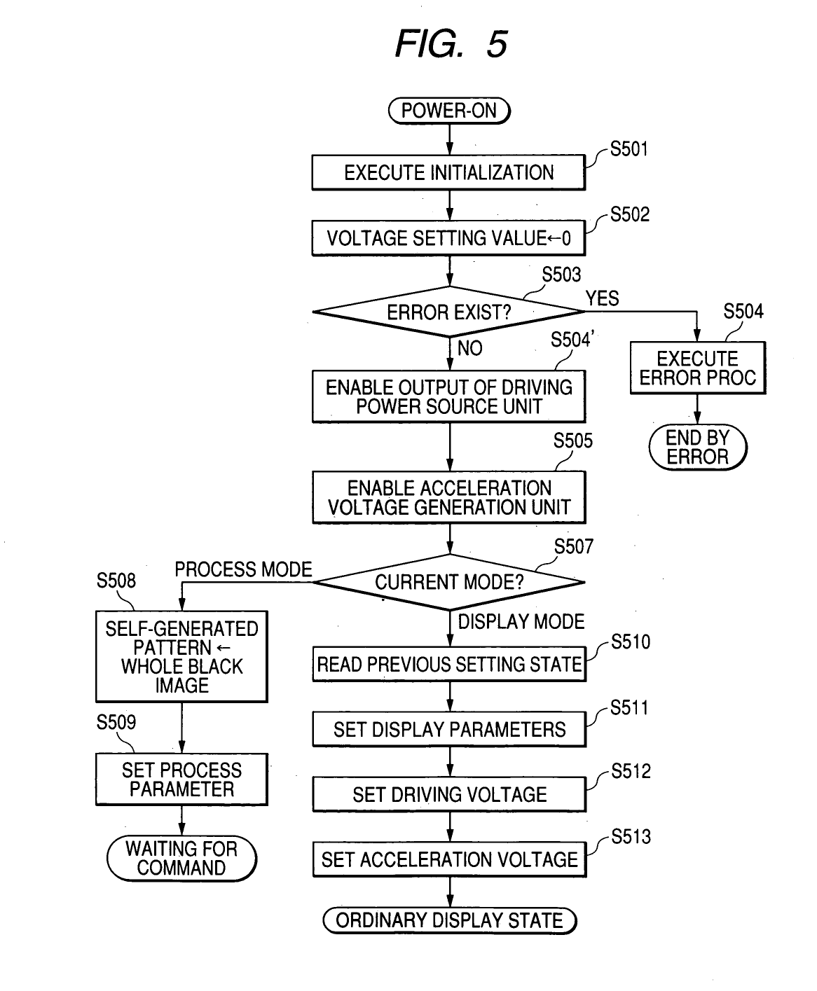

FIG. 5 is a flow chart for explaining the operation by the microcomputer of the module control unit to be executed when power is supplied to the module. Here, since the processes in steps S501 to S504 of FIG. 5 are substantially the same as those in the steps S301 to S304 of FIG. 3, the detailed explanation thereof will be omitted.

That is, when any error is not found in the error check of the step S503, the flow advances to a step S504′ to enable the output of the driving power source unit 3. Then, the flow further advances to a step S505 to enable the output of the acceleration voltage generation unit 5. Here, the setting value of each of the driving voltage and the acceleration voltage is set to zero in the step S502. Therefore, even if it enables the outputs, any voltage is not applied to the display panel 1.

Besides, the processes in steps S507 to S511 of FIG. 5 are substantially the same as those in the steps. S305 to S309 of FIG. 3 in the first embodiment, the process in a step S512 of FIG. 5 is substantially the same as that in the step S311 of FIG. 3, and the process in a step S513 of FIG. 5 is substantially the same as that in the step S313 of FIG. 3. For these reasons, in the second embodiment, it is possible to achieve the operation same as that in the first embodiment.

### Third Embodiment

In the above first-embodiment, when the process mode is being set, the self-generated timing is set to the timing generation unit 7, and the parameter is set so that the self-generated pattern is selected (see step S307 of FIG. 3). Meanwhile, in the third embodiment, even if the process mode is set, the parameter suitable for the process mode is set to each of the constituent elements.

More specifically, in the step S307 of FIG. 3, the various parameters are set to each of the column wiring driver 2, the row wiring driver 4, the signal processing unit 6, and the timing generation unit 7. Here, it should be noted that, unlike the parameter set in the step S309 of FIG. 3, the parameters to be set here are the parameters which are best suitable for the respective processes to be executed.

These parameters are stored in a program ROM (not shown) or the nonvolatile memory 9. For example, when a video is displayed, the signal process and correction are executed so that the video signal and luminance are linearly corresponding to each other, so at to satisfactorily display the video. However, for example, when characteristic evaluation or driving adjustment is executed, if the pulse width and the amplitude for driving the elements are linearly corresponding to the self-generated display data, data analysis can be achieved more easily. In other words, if an ABL (Auto Brightness Limiter) or the like acts, there is a fear that a correct process cannot be executed. For this reason, in the process mode, it is desirable to set with respect to each constituent element the parameter which is quite different from that in the image display mode. That is, to turn on a certain function and to set a desired parameter according to the content of the process can be executed in response to an externally input command, whereby it is possible to achieve the process in the necessary condition.

Thus, in addition to the effect of the first embodiment, it is possible in the present embodiment to attain the effect that, since the basic parameter for the process mode is set to the previously determined value, a desired process can be executed by rewriting only necessary parameters according to the content of the process.

In the above first to third embodiments, the two kinds of mode, that is, the process mode and the display mode, are provided. However, it is possible to provide three or more kinds of modes. For example, it is possible to further divide the display mode into a service mode and a user mode and to limit the kinds of parameters capable of being set in the user mode.

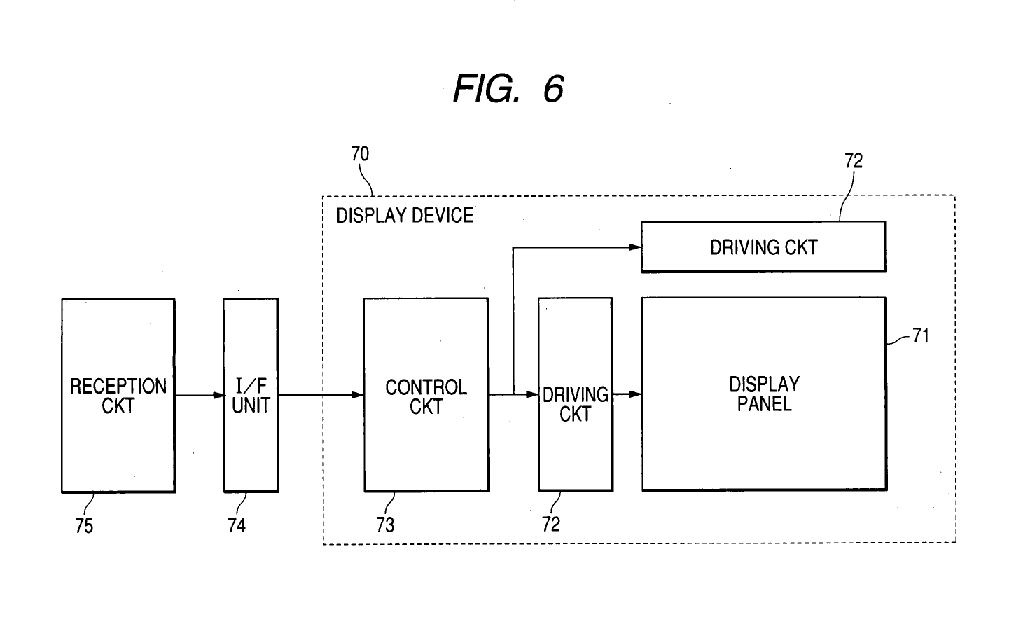

Moreover, the display device according to the present invention is also applicable to a television device. More specifically, as shown in FIG. 6, a display device 70 consists of a display panel 71, driving circuits 72 and a control circuit 73. The control circuit 73 can execute, to input image data, an image process such as a correction process or the like suitable for the display panel 71, and can output the processed image data and various control signals to the driving circuits 72. The driving circuit 72 can output a driving signal to the display panel 71, in response to the input image data, whereby a television video is displayed on the display panel 71.

Moreover, a reception circuit 75 consists of a tuner, a decoder and the like. An interface (I/F) unit 74 transforms video data into the image data having the display format of the display device 70, and then outputs the transformed image data to the display device 70. Besides, the reception circuit 75 can receive a satellite broadcast television signal, a ground wave television signal and the like, and also can receive data broadcast through a network. Moreover, the reception circuit 75 can supply decoded video data to the I/F unit 74. Incidentally, the reception circuit 75 and the I/F unit 74 may be held within a housing as a set-top box different from the housing of the display device 70, or may be held within the housing of the display device 70.

This application claims priority from Japanese Patent Application No. 2004-193946 filed Jun. 30, 2004, which is hereby incorporated by reference herein.

What is claimed is:

1. A display device comprising:
a display panel adapted to display an image;
a driving unit adapted to drive said display panel; and
a driving power source unit adapted to supply power to said driving unit,
wherein said display device has a process mode in which said driving power source unit is controlled based on an externally input command and a display mode in which said driving power source unit is controlled based on a predetermined sequence.

2. A display device according to claim 1, wherein, after a main power source is turned on, said driving power source unit is in a standby-state of not supplying the power to said driving unit when the process mode is being set, and said driving power source unit is in an on-state of automatically supplying the power to said driving unit when the display mode is being set.

3. A display device comprising:
a display panel adapted to display an image;
a driving unit adapted to apply a driving voltage to said display panel; and
a driving power source unit adapted to supply power to said driving unit,
wherein, after a main power source is turned on, said display device has a process mode in which the driving voltage is not applied to said display panel and a display mode in which the driving voltage according to a video signal is applied to said display panel.

4. A display device according to claim 3, further comprising an acceleration voltage generation circuit adapted to be able to apply an acceleration voltage to said display panel,
wherein, in the process mode, said acceleration voltage generation circuit is controlled based on an externally input command, and
in the display mode, said acceleration voltage generation circuit is controlled based on a predetermined sequence.

5. A display device according to claim 4, wherein said acceleration voltage generation circuit comes to be in a state of not applying the acceleration voltage to said display panel in the process mode, and said acceleration voltage generation circuit comes to be in a state of automatically applying the acceleration voltage to said display panel in the display mode.

6. A display device according to claim 5, further comprising a signal processing unit adapted to execute a signal process to the input video signal,
wherein, in the process mode, a control parameter of said signal processing unit is set to a predetermined value, and
in the display mode, the control parameter of said signal processing unit is set to a setting value in the previous display mode.

7. A display device according to Claim.6, wherein
in the process mode, it is set to display a predetermined image on said display panel, and
in the display mode, it is set to display on said display panel an image based on the input video signal.

8. A television device comprising:
a reception circuit adapted to receive a television signal;
a driving unit adapted to output a driving signal based on the television signal;
a display panel adapted to display an image based on the driving signal; and
a driving power source unit adapted to supply power to said driving unit,
wherein it is constituted to be able to set at least two modes of a process mode in which said driving power source unit is controlled based on an externally input command and a display mode in which said driving power source unit is controlled based on a predetermined sequence.

9. A television device comprising:
a reception circuit adapted to receive a television signal;
a driving unit adapted to output a driving signal based on the television signal;
a display panel adapted to display an image based on the driving signal; and
a driving power source unit adapted to supply power to said driving unit,
wherein it is constituted to be able to set, after a power source is turned on, at least two modes of a process mode of brining about a state not applying a driving voltage to said display panel and a display mode of bringing about a state of applying the driving voltage to said display panel according to the image to be displayed.

10. A control method for a display device which has a process mode controlled based on an externally input command and a display mode controlled based on a predetermined sequence, said method comprising:
a step of turning on a main power source;
a step of initializing a microcomputer and its peripheral circuits; and
a step of making a voltage setting value of a driving power source unit zero,
wherein, in the process mode, said method further comprises
a step of designating an image of a predetermined pattern, and
a step of setting a control parameter for the process mode, and
in the display mode, said method further comprises
a step of reading from a memory a display setting in a previous display mode,
a step of setting a driving parameter based on the display setting,
a step of displaying an image based on an input video signal, by outputting the driving voltage and the acceleration voltage.
